(19) United States
(12) Patent Application Publication
(10) Pub. No.: US 2011/0142420 A1
(43) Pub. Date: Jun. 16, 2011

(54) COMPUTER DEVICE, METHOD, AND GRAPHICAL USER INTERFACE FOR AUTOMATING THE DIGITAL TRANFORMATION, ENHANCEMENT, AND EDITING OF PERSONAL AND PROFESSIONAL VIDEOS

(76) Inventor: Matthew Benjamin Singer, New York, NY (US)

(21) Appl. No.: 12/877,058

(22) Filed: Sep. 7, 2010

Related U.S. Application Data
(63) Continuation-in-part of application No. 12/693,254, filed on Jan. 25, 2010.
(60) Provisional application No. 61/205,841, filed on Jan. 23, 2009.
(60) Provisional application No. 61/239,041, filed on Sep. 1, 2009.
(60) Provisional application No. 61/311,980, filed on Mar. 9, 2010.

(51) Int. Cl. H04N 5/93

(52) U.S. Cl. 386/280; 386/282; 386/E05.003

(57) ABSTRACT

A computer-implemented method is described for automatically digitally transforming and editing video files to produce a finished video presentation. The method includes the steps of receiving from a user a selection of video clips to be made into the finished video presentation, automatically trimming the selected video clips, and automatically assembling the trimmed video clips into the finished presentation. Preferably, the method further comprises the steps of receiving a master video clip and automatically replacing portions of the master video clip with the trimmed video clips. In addition audio and visual effects may be added to the finished video presentation. Computer apparatus for performing these steps is also described.

This application is a continuation-in-part of application Ser. No. 12/693,254, filed Jan. 25, 2010, which application claims the benefit of the Jan. 23, 2009 filing date of provisional application Ser. No. 61/205,841 and the Sep. 1, 2009 filing date of provisional application Ser. No. 61/239,041 and is a continuation-in-part of provisional application No. 61/311,980, filed Mar. 9, 2010, all of which applications are incorporated herein by reference.

### BACKGROUND

This relates to the digital transformation, enhancement, and editing of personal and professional videos.

Millions of video cameras and computer and photo devices that record video are sold worldwide each year in both the professional and consumer markets. In the professional video production sphere, billions of dollars and significant time resources are spent editing video—taking raw footage shot with these cameras and devices, loading it into manual video editing software platforms, reviewing the footage to find the most compelling portions, and assembling the compelling portions in a fashion that communicates or illustrates the requisite message or story in a focused, engaging way, while adding professional footage transitions, soundtrack layers, and effects to enhance the resultant video.

With all the time, money, and expertise necessary to edit video to a professional level or compelling presentation level, the video editing process can be a daunting task for the average consumer. Even for the video editing professional, high quality video production workflow can take 30× the resultant video time. For example, a finished two-minute video typically takes 75 minutes to edit using traditional manual video editing software. Beyond the significant time investment, the video editing software technical skill necessary and the advanced shot sequencing, enhancing, and combining expertise are skills that the average consumer does not have and that the professional producer acquires at great cost.

For these reasons, the average consumer typically does not have the resources to transform the raw footage he or she films into professional grade video presentations, often instead settling for overly long collections of un-edited video clips that are dull to watch due to their rambling, aimless nature in aggregate. In the alternative, the consumer might hire a professional video editor for events such as weddings, birthdays, family sports events, etc. and spend significant funds to do so. Accordingly, there is a need for methods and apparatus that can transform the process of creating videos through automation of the creation, enhancement, and editing of audiovisuals, using machines that are easy to use, configure, and/or adapt. Such machines would increase the effectiveness, efficiency and user satisfaction with producing polished, enhanced video content, thereby opening up the proven, powerful communication and documentation power of professionally edited video to a much wider group of business and personal applications.

### SUMMARY OF THE PRESENT INVENTION

The above deficiencies and other problems associated with video production are reduced or eliminated by the disclosed multifunction device and methods. In some embodiments, the device is a camera or mobile device inclusive of a camera with a graphical user interface (GUI), one or more processors, memory, and one or more modules, programs or sets of computer instructions stored in the memory for performing multiple functions either locally or remotely via a network. In some embodiments, the user interacts with the GUI primarily through a local computer and/or camera connected to the device via a network or data transfer interface. Computer instructions may be stored in a computer readable storage medium or other computer program product configured for execution by one or more processors.

In one embodiment, the computer instructions include instructions that, when executed, digitally transform and automatically edit video files into finished video presentations based on the following:

1. User selection of sub-clips from video files;

2. User creation of one or more master clips;

3. Automatic trimming of sub-clips based on pre-specified formulas;

4. Automatic replacement of video in the master clip(s) with video from the sub-clips; and

5. Automatic addition of visual effects to the master clip(s) and sub-clips.

In some embodiments, additional efficiencies may also be achieved by extracting from the video file any still images that may be needed for the video presentation, or adding in and enhancing still images into the finished edited video. Such image or images may be extracted automatically from specified portions of the finished video presentation or they may be extracted manually using a process in which the user employs an interface to view and select the optimal video frame(s), or with the still images supplied by the user and/or created with the camera device or another camera device(s).

In some embodiments, the finished video presentation can be automatically uploaded to a different device, server, web site, or alternate location for public or private viewing or archiving.

The above embodiments can be used in numerous types of sales, event, documentary or presentation video applications by individuals or businesses, including wedding videos, travel videos, birthday videos, baby videos, apartment videos, product sales videos, graduation videos, surf/skate/action videos, recital, play or concert videos, sports videos, pet videos.

### BRIEF DESCRIPTION OF THE DRAWINGS

These and other objects, features and advantages will be more readily apparent from the following Detailed Description in which:

FIG. 1 is a schematic diagram of an illustrative computing device used in the practice of the invention;

FIG. 2 is a flowchart depicting several steps in an illustrative embodiment of the method of the invention;

FIG. 3 is a schematic diagram depicting the application of an illustrative embodiment of an automatic video editing algorithm to a master clip and sub-clips in an illustrative embodiment of the invention; and

FIGS. 4A-4L depict the video screen of a hand-held display such as that of a cell-phone during execution of certain of the steps of FIG. 2.

### DETAILED DESCRIPTION

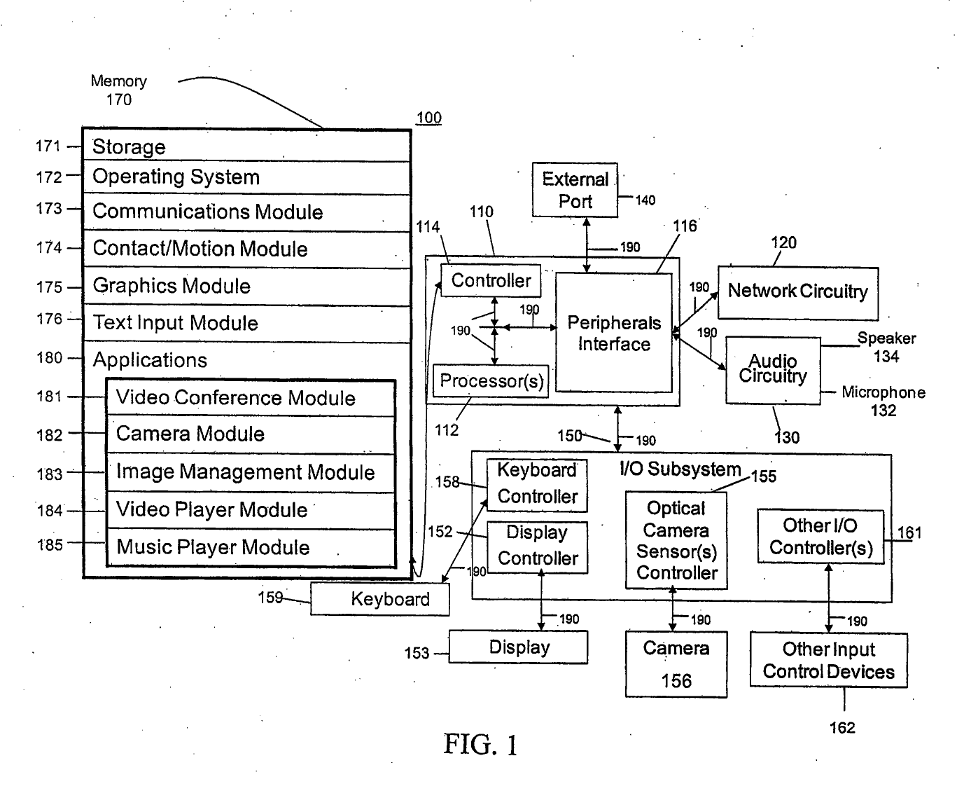

FIG. 1 is a schematic diagram of a computing device 100 used in the practice of the invention. Reference is made in detail to embodiments, examples of which are illustrated in the accompanying drawings. In the following schematic, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

Device 100 comprises a processing unit 110, network interface circuitry 120, audio circuitry 130, external port 140, an I/O subsystem 150 and a memory 170. Processing unit comprises one or more processors 112, a memory controller 114, and a peripherals interface 116, connected by a bus 190. I/O subsystem includes a display controller 152 and a display 153, one or more camera controllers 155 and associated camera(s) 156, a keyboard controller 158 and keyboard 159, and one or more other I/O controllers 161 and associated I/O 162. Memory 170 provides general purpose storage 171 for device 100 as well as storage for software for operating the device including an operating system 172, a communication module 173, a contact/motion module 174, a graphics module 175, a text input module 176, and various application programs 180. The applications programs include a video conference module 182, a camera module 183, an image management module 184, a video player module 185 and a music player module 186.

The network interface circuitry 120 communicates with communications networks via electromagnetic signals. Network circuitry 120 may include well-known communication circuitry including but not limited to an antenna system, a network transceiver, one or more amplifiers, a tuner, one or more oscillators, a digital signal processor, a CODEC chipset, a subscriber identity module (SIM) card, memory, and so forth. Network circuitry 120 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 130, including a microphone 132 and a speaker 134, provides an audio interface between a user and the device 100. The audio circuitry 130 receives digital audio data from the peripherals interface 116, converts the digital audio data to an analog electrical signal, and transmits the electrical signal to the speaker 134. The speaker 134 converts the analog electrical signal to human-audible sound waves. The audio circuitry 130 also receives analog electrical signals converted by the microphone 132 from sound waves and converts the analog electrical signal to digital audio data that is transmitted to the peripherals interface 116 for processing. Digital audio data may be retrieved from and/or transmitted to memory 170 and/or the network interface circuitry 120 by the peripherals interface 116. In some embodiments, the audio circuitry 130 also includes a USB audio jack. The USB audio jack provides an interface between the audio circuitry 130 and removable audio input/output peripherals, such as output-only headphones or a microphone.

The I/O subsystem 150 couples input/output peripherals on the device 100, such as a display 153, a camera 156, a keyboard 159 and other input/control devices 162, to the peripherals interface 116. The I/O subsystem 150 may include a display controller 152, a camera controller 155, a keyboard controller 158, and one or more other input/output controllers 161 for other input or output devices. The one or more other I/O controllers 161 receive/send electrical signals from/to other input/output devices 162. The other input/control devices 162 may include physical buttons (e.g., push buttons, rocker buttons, etc.), dials, slider switches, joysticks, click wheels, and so forth. In some alternate embodiments, I/O controller(s) 161 may be coupled to any (or none) of the following: an infrared port, USB port, and a pointer device such as a mouse. The one or more buttons may include an up/down button for volume control of the speaker 134 and/or the microphone 132.

The device 100 may also include one or more video cameras 156. The video camera may include charge-coupled device (CCD) or complementary metal-oxide semiconductor (CMOS) phototransistors. The video camera receives light from the environment, projected through one or more lens, and converts the light to data representing an image. In conjunction with an imaging module, the video camera may be embedded within the computing device, and in some embodiments, the video camera can be encompassed in a separate camera housing for both video conferencing and still and/or video image acquisition.

Memory 170 may include high-speed random access memory and may also include non-volatile memory, such as one or more magnetic disk storage devices, flash memory devices, or other non-volatile solid-state memory devices. Access to memory 170 by other components of the device 100, such as the processor(s) 112 and the peripherals interface 116, may be controlled by the memory controller 114.

The operating system 172 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 173 facilitates communication with other devices over one or more external ports 140 and also includes various software components for handling data received by or transmitted from the network interface circuitry 120.

The graphics module 175 includes various known software components for rendering and displaying the GUI, including components for changing the intensity of graphics that are displayed. As used herein, the term “graphics” includes any object that can be displayed to a user, including without limitation text, icons (such as user-interface objects including soft keys), digital images, videos, animations and the like.

In conjunction with keyboard 159, display controller 152, camera(s) 156, camera controller 155, microphone 132, and graphics module 175, the camera module 183 may be used to capture still images or video (including a video stream) and store them in memory 170, modify characteristics of a still image or video, or delete a still image or video from memory 170. Embodiments of user interfaces and associated processes using camera(s) 156 are described further below.

In conjunction with keyboard 159, display controller 152, display 153, graphics module 175, audio circuitry 130, and speaker 134, the video player module 185 may be used to display, present or otherwise play back videos (on an external, connected display via external port 140 or an internal display). Embodiments of user interfaces and associated processes using video player module 185 are described further below.

It should be appreciated that the device 100 is only one example of a multifunction device, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

In some embodiments, the peripherals interface 116, the CPU 112, and the memory controller 114 may be implemented on a single integrated circuit chip. In some other embodiments, they may be implemented on separate chips.

As set forth above, software for controlling the operation of device 100 is stored in memory 170. In accordance with the invention, the software includes instructions that when executed by processor(s) 112 cause device 100 to automatically edit video files stored in memory 170 to produce a finished video presentation.

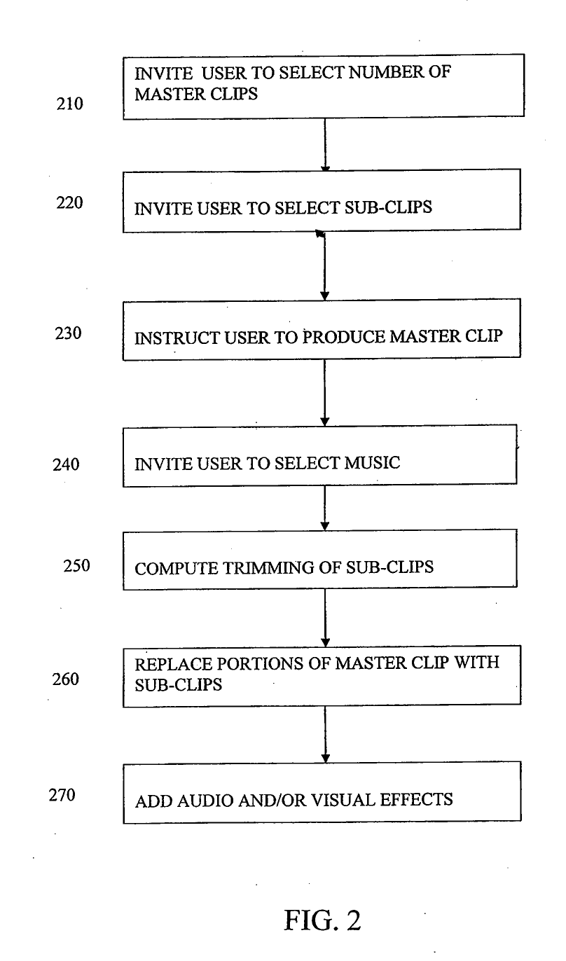

FIG. 2 is a flowchart depicting the steps performed by the software of device 100 in an illustrative embodiment of the invention. To edit the video files, the software is either preconfigured or is configured by the user as to how many master clips will be in the finished video presentation that is produced in a particular editing assignment. Thus, in some embodiments of the invention, the user is offered no choice in the number of master clips; and the software utilizes a preconfigured number of master clips, for example, one, in each automatic video editing assignment. In other embodiments, when the software is activated, the user is invited at step 210 to specify how many master clips he would like in the finished video presentation. Illustratively, device 100 presents on display 153 a message asking the user how many master clips he would like to use; and the user may respond by entering a number via keyboard 159. Alternatively, the user may be queried by a voice message using speaker 134; and the user may respond with a spoken number. Rather than request a number from the user, device 100 may ask the user to specify what type of video presentation is being edited; and the software may determine from a pre-loaded table the number of master clips to be used with that type of presentation. In some embodiments, the number determined from the look-up table might then be altered by the user. Where the user is asked to specify the type of video presentation, device 100 advantageously presents on display 153 a list of different types of video presentations and requests the user to select the one that best describes the video files that are to be edited.

At step 220, the software generates an invitation to the user to select the video sub-clips to be included in the finished video presentation. Typically, the invitation is displayed to the user on display 153 or spoken to the user by speaker 134. In response, the user informs device 100 of his or her selection of the sub-clips. Advantageously, device 100 presents on display 153 thumb-nail images representing each of the available sub-clips and invites the user to select the sub-clips that are desired for incorporation into the finished video. If display 153 is a touch screen, the user can make his or her selection simply by touching the associated thumb-nail images. Otherwise, the user can scroll to the desired thumb-nail images and select them by using appropriate scrolling and selection buttons. Alternatively, the user can make the selection by issuing appropriate voice commands that are received by microphone 132. Advantageously, the order of selection determines the order of the sub-clips in the finished video presentation.

At step 230, a master clip is created. The software generates an instruction to the user to produce the master clip. Again, device 100 can present this instruction visually by display 153 or audibly by speaker 134. In response, the user presents the master clip which is recorded visually and aurally by camera 156 and microphone 132. Advantageously, the display, camera, microphone and speaker may all be part of a cell-phone such as an iPhone or similar device.

At step 240, the software generates an invitation to the user to select a music soundtrack for use in the finished video presentation. Illustratively, this is done by displaying a list of available soundtracks on display 153 and inviting a selection by use of a touch screen or scrolling and selection buttons.

Once the sub-clips have been selected and the master clip has been recorded, device 100 automatically computes the trimming of the sub-clips at step 250 using a pre-specified algorithm. In one embodiment, the algorithm limits the temporal duration of the finished video presentation to the temporal duration of the master clip, allows a few seconds at the beginning and end of the final video for display of the beginning and end of the master clip, and allocates the remaining duration of the master clip in equal amounts to the selected sub-clips. In other embodiments, the user can select the length of the finished video presentation; or device 100 can use a pre-loaded table to determine the length of the presentation depending on the type of presentation. Whatever method is used to determine the length of the final video presentation, the total length of the sub-clips will generally be greater; and the sub-clips will have to be trimmed to fit the available time.

In accordance with the invention, each sub-clip is trimmed about a trimming center so that there is an equal amount of time in the trimmed version of the sub-clip before and after the trimming center. Regardless of the length of the different sub-clips, it has been found that good quality final videos are produced when each trimming center is located at the same relative point in time from the beginning of the sub-clip. Typically, this point is somewhere in the range of 30 to 70 percent (%) of the temporal duration of the sub-clip. Preferably, this point is about 55 percent of the temporal duration of the sub-clip. Thus, if 30 seconds are allotted to the trimmed version of each sub-clip and one sub-clip is 100 seconds long and a second sub-clip is 60 seconds long, the trimming center of the first sub-clip is 55 seconds from the start of the untrimmed version of the sub-clip; and the trimmed version of that sub-clip begins 40 seconds and ends 70 seconds from the start of the untrimmed version. Similarly, the trimming center of the second sub-clip is 33 seconds from the start of the untrimmed version of the second sub-clip; and the trimmed version begins 18 seconds and ends 48 seconds from the start of the untrimmed version. In summary, the trimming process locates the trimming center in each sub-clip at a percentage of the distance from the start of the sub-clip and locates a trimming start point and a trimming end point at a specific time interval before and after the trimming center.

In some embodiments, the location of the trimming center could vary from clip to clip depending on the original length of the clip. For example, longer clips could have the trimming center at 60% because the user took longer to film their material and thus the best material that occurred during the time in which he was filming took a longer time to materialize, and, alternatively, the trimming center could be at 50% for shorter clips because the best material that occurred during the time in which he was filming took a shorter time to materialize and thus occurred earlier in the clip. In such embodiments, a look-up table in the device's software provides the appropriate trimming centers based on the original length of the sub-clips. In some embodiments, the trimming center could vary from clip to clip depending on the type of video presentation as specified by a look-up table. For example, in creating a sales video, the user may consciously create a sub-clip that demonstrates a product attribute and thus the user may film an important portion of the demonstration towards the beginning the sub-clip, so the trimming center could be at 30% for sub-clips for a sales presentation video that include demonstrations in order to feature the most relevant footage.

Furthermore, in some embodiments, one or more of the sub-clips can be animated photos, where the user selects a photo as the sub-clip source, and the photo is then transformed into a video clip by the device by reusing pixels from the photo in successive frames with a visual transformation (such as zooming in on the photo), and the length of the animated photo sub-clip generated by the device is determined by the length allotted for each trimmed subclip.

After the trimming is computed, at step 260 device 100 automatically replaces the video in the master clip with the video from the trimmed versions of the sub-clips. In the embodiment where the length of the finished video presentation is the length of the master clip, the first few seconds of the master clip are left untouched. Thereafter, the video is replaced by the trimmed versions of the sub-clips in the order in which they were selected. This process leaves a few seconds of the master clip untouched at the very end. In a preferred embodiment of the invention, the audio of the master clip is retained and the audio of the sub-clips is dropped.

Finally, at step 270, audio effects such as the previously selected music track and visual effects such as fades and dissolves are automatically added to the master clip and trimmed sub-clips to produce the finished video presentation.

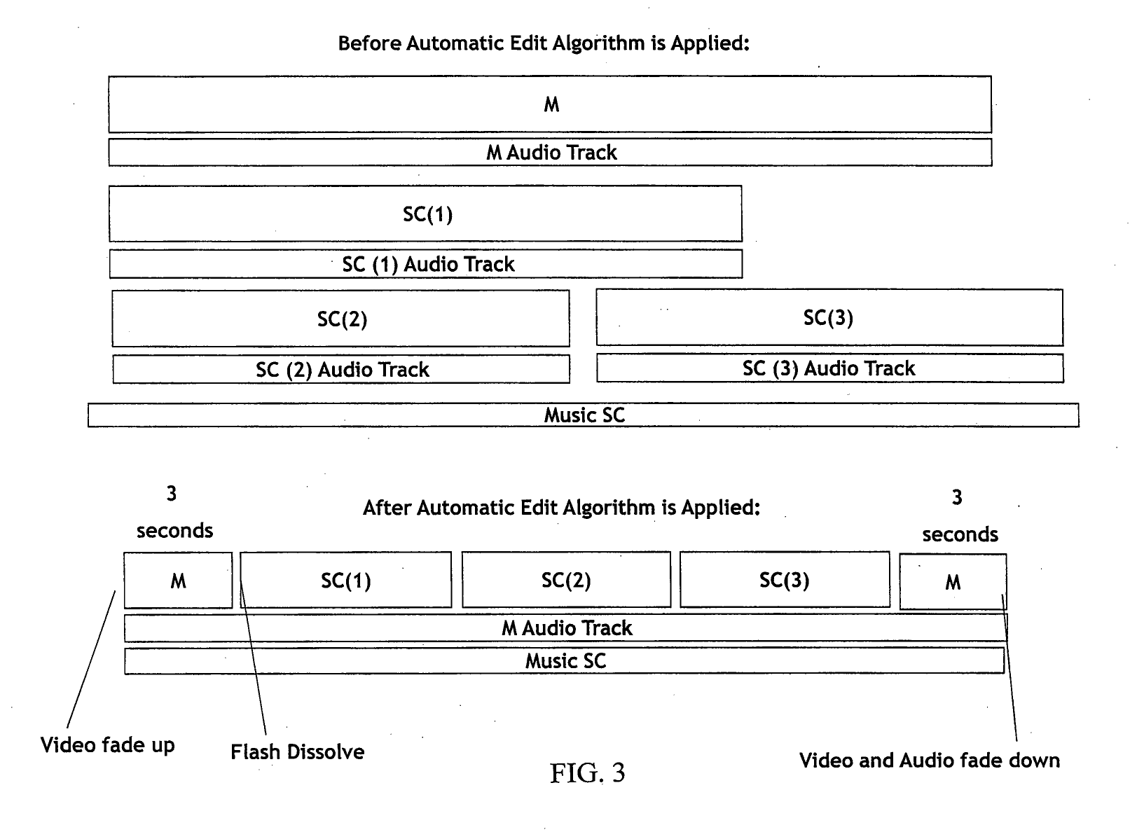

FIG. 3 is a schematic diagram illustrating the video editing algorithm of FIG. 2. Before the algorithm is applied, the user generates a master clip M at step 230 and identifies several sub-clips SC(1), SC(2) and SC(3) at step 220. Each clip has its own audio track. The video sub-clips SC(1), SC(2), and SC(3) are then automatically trimmed at step 250 and inserted at step 260 into the video track of the master video clip; but the audio sub-clips are removed. A music sub-clip is added at step 270 to the final video at a lower volume level underneath the entire final video; and special effects are applied. In summary, by combining the user selected sub-clips, device directed master clip (s), and the automatic editing algorithms, the finished video presentation can be automatically assembled without further user input in a machine based transformation much faster than with traditional manual video editing software.

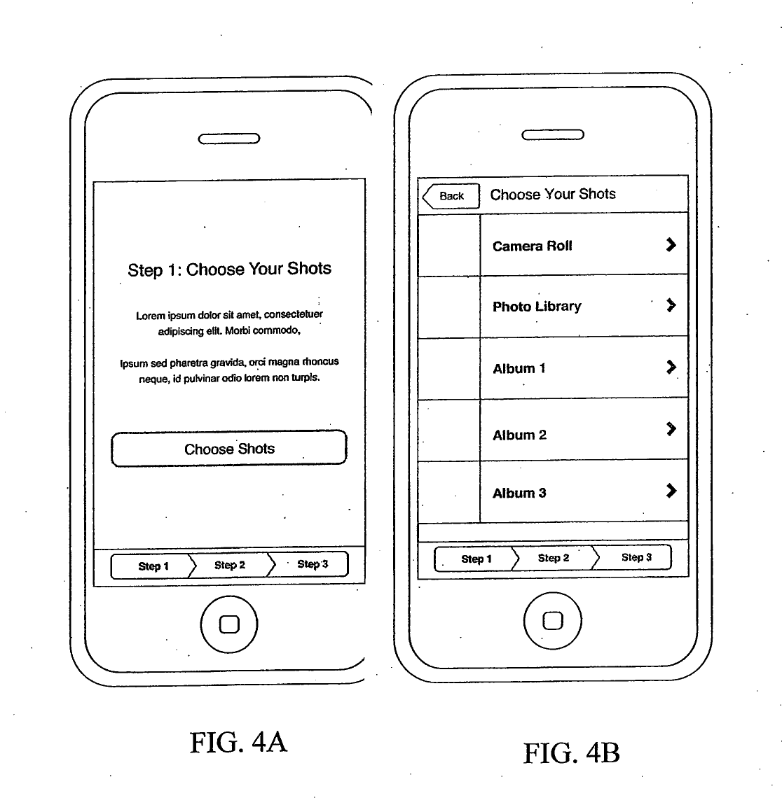

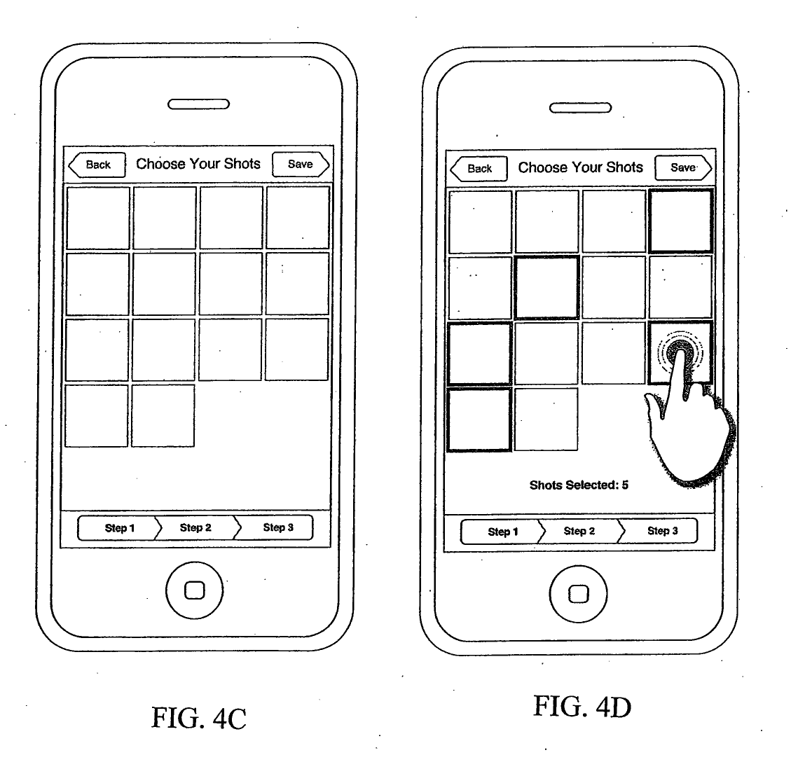

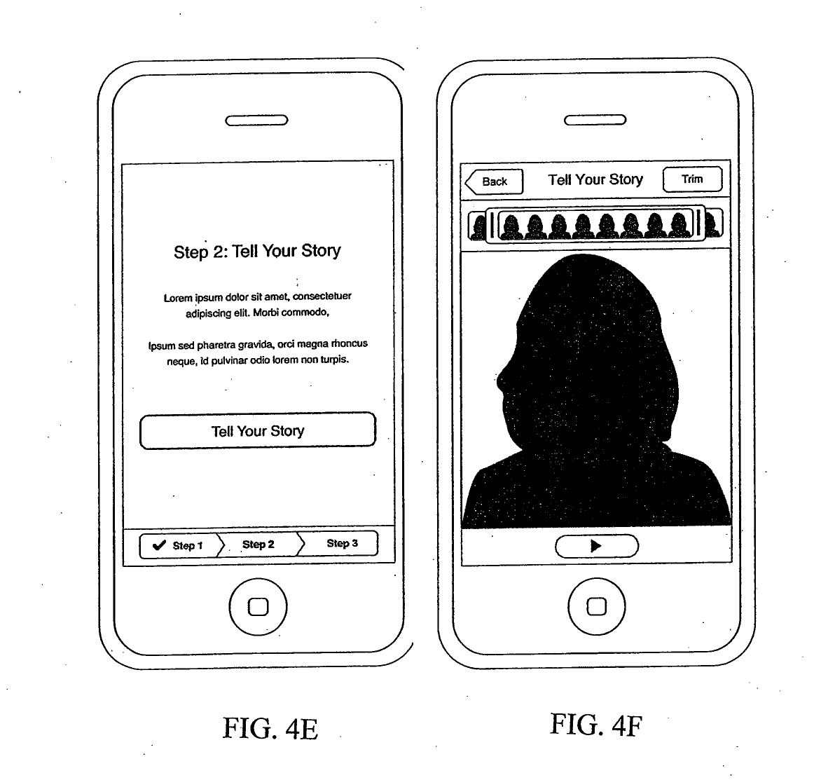

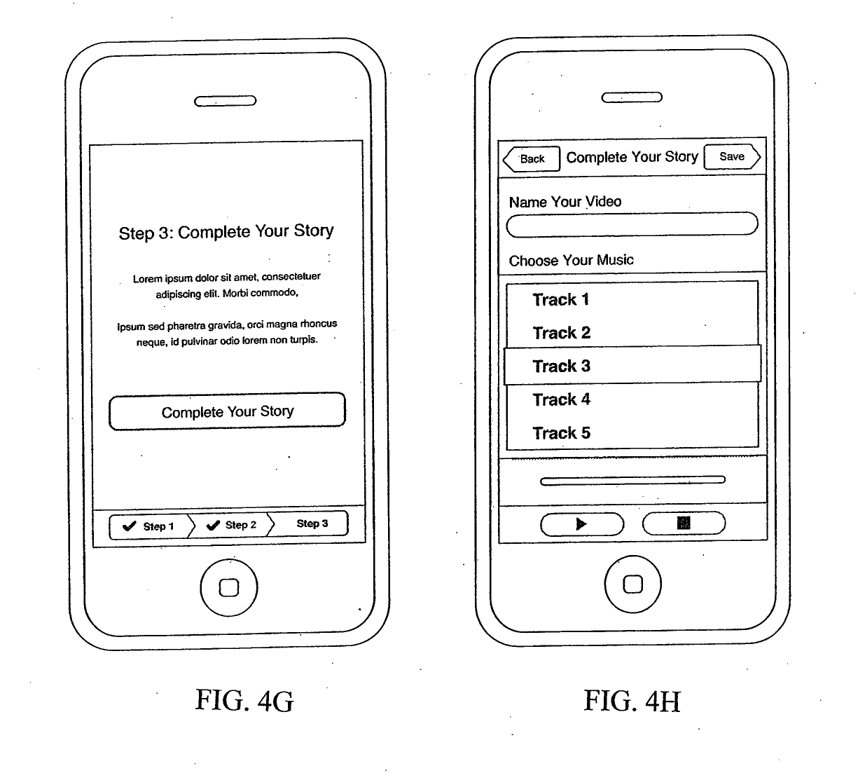

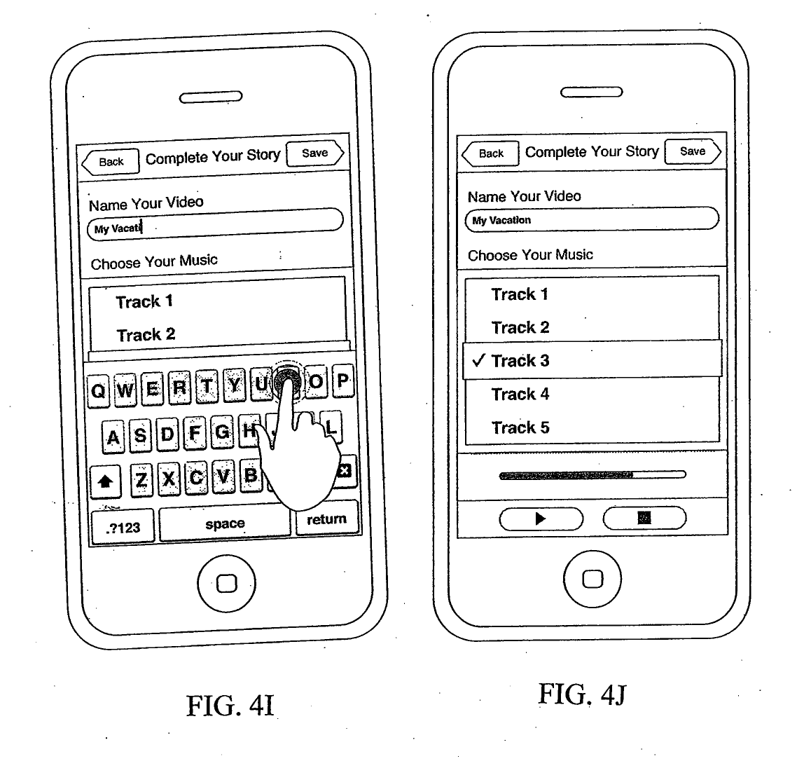

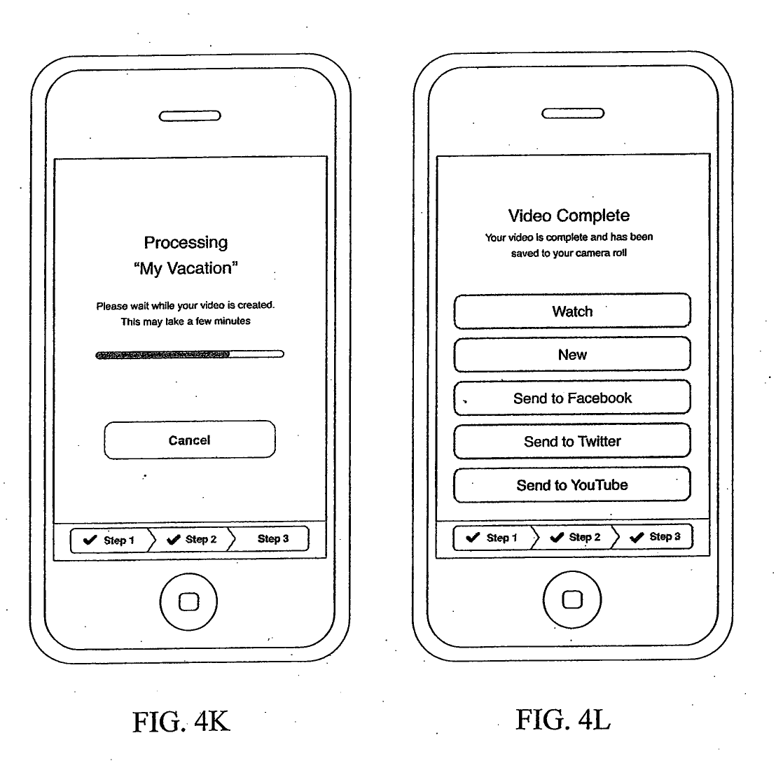

FIGS. 4A-4L depict the display of a hand-held device such as a cell-phone during execution of some of the steps of FIG. 2. FIGS. 4A-4D illustrate the user choosing previously created video segments and photos as in step 220. The device designates these previously created video segments and photos as “sub-clips.” FIGS. 4E-4F illustrate the device instructing the user as in step 230 to create a master clip. The master clip is a user supplied description of the sub-clips selected by the user, with the user featured on camera within the newly created master clip. FIGS. 4G-4J illustrate the device receiving audio sub-clip selections from the user as in step 240 as well as text based name or description information on the collective video subject. FIG. 4K illustrates the device automatically editing the video as in step 250 based on an algorithmic formula determining the edited relationship between the master clip and sub-clips. FIG. 4L illustrates that the user can review the final enhanced video, repeat previous steps, save the final video, or distribute the video including but not limited to distributing via Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Specific examples of the invention are as follows.

A) Vacation Video

User takes a trip to Paris and films several video clips of varying lengths, including user in front of the Eiffel tower, the view from the user's hotel room, the bustle of the streets of Paris, and a sunset view from a Paris café. The video clips were filmed with the video camera embedded within the invention. Then, with no manual video editing background and just a minute or two, user is able to transform his raw video clips with the invention into a compelling, compact, mini-documentary about his trip, using the following steps.
i) STEP 1: the user uses the graphic interface of device 100 to select his favorite clips that he previously filmed on the Paris trip. The clips can be of any length, for example, from 1 minute long each to 3 minutes long. The user selects the four example clips above. The invention designates these clips as sub-clips.
ii) STEP 2: device 100 directs the user to create a new video clip where the user, looking into the invention's camera, summarizes the overall story told by the sub clips selected by the user. Since these clips show the romance and beauty of Paris, the user films a clip of himself saying “I love Paris, it's so romantic, you have amazing food, gorgeous views, and it's a place with an old world feel that really inspires you—I had a great time there.” The invention designates this clip as a master clip.
iii) STEP 3: device 100 directs the user to select a music soundtrack.
After the three steps are complete, the invention performs the following transformations:
i) Automatic trims of sub clips. One of the most time consuming parts of manual video editing is trimming the length of video clips, so that the resultant video is not a long series of raw, boring video clips. The invention trims down the length of the sub clips automatically. In this example, the invention's automatic edit algorithm uses the length of the master clip to determine the automatic trimming of the sub clips. The length of the master clip will be the length of the final automatically edited video. Taking the master clip length and subtracting a buffer time determines the total length available for the sub clips. For example, if the master clip is 22 seconds, and the master clip buffer time is 6 seconds, then the available length for the sub clips is 16 seconds. Because the user selected the four clips above as the sub clips, then each clip will be trimmed down automatically to 4 seconds each. In this example, the 55% point in the length of each sub clip is set by the invention as the trim middle point (or trimming center). So each clip is trimmed to 4 seconds in length, keeping 2 seconds prior and 2 seconds after the middle point set at 55% through the length of each sub clip. The trim middle point could be a range, but in most cases the trim middle point will be near the middle of the sub clip because statistically when all users create video clips the best material is most often located towards the center point of the clip.
ii) Automatic replacement of master clip video portions with sub clips. One of the most important goals of video editing is to communicate more information in less time. For example, in a newscast, if a presenter states for 10 seconds that there are protests at a convention, and then 10 seconds of protest video footage is shown, this information was communicated in 20 seconds. If, alternatively, a presenter states for 10 seconds that there are protests at a convention, and within that 10 seconds, portions of the video footage showing the presenter are replaced with portions of the protest video footage, then the same amount of information was delivered in 10 seconds—a communication efficiency gain of 100% over the 20 second sequential example above. Increase efficiency of information communication has the end result of making a finished video more engaging, watchable, entertaining, and powerful as a communication device. Now, in terms of the Paris vacation video example herein, the invention will take the automatically trimmed sub clips and insert them into the video portion of the master clip leaving a portion of the master clip buffer time on each side. In this example, the master clip buffer time is divided equally, so that there are 3 seconds of master clip buffer at the beginning of the final video transformed by the invention and there are 3 seconds of master clip buffer at the end of the final video. Therefore, the invention automatically inserts the video portions of the automatically trimmed sub clips so that the final video transformed by the invention is sequenced as follows:

a) the first 3 seconds of the video feature the master clip video and audio (“I love Paris” with the user's face showing on camera), then,

b) the next 16 seconds of the final video show the video of the 4 automatically trimmed sub clips, at 4 seconds each, with the audio of the master clip playing at the same time (“it's so romantic, you have amazing food, gorgeous views, and it's a place with an old world feel that really inspires you” is the audio playing while the four clips—the Eiffel tower, the view from the hotel room, the bustle of the streets and the view from the café, are displayed visually), then

c) the final 3 seconds of the final video return to the final 3 seconds of the video and audio of the master clip (“—I had a great time there” is the audio played while the corresponding video footage of the user speaking this final phrase is displayed).

Therefore, instead of sequencing the clips in their original length (22 second master clip plus the original sub-clip lengths of 1-3 minutes each), the total final automatically edited video is only 22 seconds long, an enormous efficiency increase.
iii) automatic additional of visual effects and music. The music track sub clip chosen by the user is added to the master clip soundtrack at a lower volume. In this example, automatically taking 15-45 db off of the volume of the music track will typically be sufficient to hear the music track but not cover up the audio of the master clip. In addition, the following visual effects are automatically added to programmatically enhance the visual interest of the final video transformed by the invention:

a) The beginning of the video is enhanced with a fade up from black;

b) The end of the video is enhanced with a fade down to black;

c) The video transition between the master clip video and the first sub clip video inserted is smoothed by a transition such as a white flash, in which the video brightness is increased by 20% for 5 frames before the transition point and 5 frames after the transition point (Other effects to ease the transition can be used such as a dissolve for varying lengths); and

d) The video transition between the end of the final sub clip and the master clip is also smoothed by a transition effect such as the white flash described above.

The final result is a polished 22 second video featuring visually interesting visual effects based on professional art direction standards, fast moving clip density, and exceptional communication efficiency—all with just three steps by the user (choosing sub clips, recording master clip, choosing music), done in one or two minutes, with no professional editing background skills needed. In this example, the video is automatically uploaded to the user's social networking web site account.

B) Family Video

User spends time on the weekends with his twin daughters and films several video clips of varying lengths, including the twins smiling at each other at the dinner table, the twins walking hand and hand down the street, and the twins going down a slide at the playground. The video clips were filmed with the video camera embedded within the invention. Then, with no manual video editing background and just a minute or two, user is able to transform his raw video clips with the invention into a compelling, compact, mini-documentary about his children, using the following steps.
i) STEP 1: the user uses the graphic interface of device 100 to select his favorite clips that he previously filmed with his children. The clips can be of any length, for example, from 1 minute long each to 3 minutes long. The user selects the three example clips above. The invention designates these clips as sub-clips.
ii) STEP 2: device 100 directs the user to create a new video clip where the user, looking into the invention's camera, summarizes the overall story told by the sub clips selected by the user. Since these clips show his children interacting with each other in various ways, the user films a clip of himself saying “Gemma and Eliana are great kids, they get along really well, and I think as they grow up they'll continue to be best friends.” The invention designates this clip as a master clip.
iii) STEP 3: device 100 directs the user to select a music soundtrack.
After the three steps are complete, the invention performs the following transformations:
i) Automatic trims of sub clips. The invention trims down the length of the sub clips automatically. In this example, the invention's automatic edit algorithm uses the length of the master clip to determine the automatic trimming of the sub clips. The length of the master clip will be the length of the final automatically edited video. Taking the master clip length and subtracting a buffer time determines the total length available for the sub clips. For example, if the master clip is 15 seconds, and the master clip buffer time is 6 seconds, then the available length for the sub clips is 9 seconds. Because the user selected the three clips above as the sub clips, then each clip will be trimmed down automatically to 3 seconds each. In this example, the 55% point in the length of each sub clip is set by the invention as the trim middle point (or trimming center). So each clip is trimmed to 3 seconds in length, keeping 1.5 seconds prior and 1.5 seconds after the middle point set at 55% through the length of each sub clip. The trim middle point could be a range, but in most cases the trim middle point will be near the middle of the sub clip because statistically when all users create video clips the best material is most often located towards the center point of the clip.
ii) Automatic replacement of master clip video portions with sub clips. Now, in terms of the family video example herein, the invention will take the automatically trimmed sub-clips and insert them into the video portion of the master clip leaving a portion of the master clip buffer time on each side. In this example, the master clip buffer time is divided equally, so that there are 3 seconds of master clip buffer at the beginning of the final video transformed by the invention and there are 3 seconds of master clip buffer at the end of the final video. Therefore, the invention automatically inserts the video portions of the automatically trimmed sub clips so that the final video transformed by the invention is sequenced as follows:

d) the first 3 seconds of the video feature the master clip video and audio (“Gemma and Eliana are great friends” with the user's face showing on camera), then,

e) the next 9 seconds of the final video show the video of the 3 automatically trimmed sub clips, at 3 seconds each, with the audio of the master clip playing at the same time (“they get along really well, and I think as they grow up they'll continue to be” is the audio playing while the three clips—the dinner interaction, walking hand in hand in the street, and sliding down the slide, are displayed visually), then

f) the final 3 seconds of the final video return to the final 3 seconds of the video and audio of the master clip (“—best friends” is the audio played while the corresponding video footage of the user speaking this final phrase is displayed).

Therefore, instead of sequencing the clips in their original length (15 second master clip plus the original sub clip lengths of 1-3 minutes each), the total final automatically edited video is only 15 seconds long, an enormous efficiency increase.
iii) automatic addition of visual effects and music. The music track sub-clip chosen by the user is added to the master clip soundtrack at a lower volume. In this example, automatically taking 15-45 db off of the volume of the music track will typically be sufficient to hear the music track but not cover up the audio of the master clip. In addition, the following visual effects are automatically added to programmatically enhance the visual interest of the final video transformed by the invention:

a) The beginning of the video is enhanced with a fade up from black;

b) The end of the video is enhanced with a fade down to black;

c) The video transition between the master clip video and the first sub clip video inserted is smoothed by a transition such as a white flash, in which the video brightness is increased by 20% for 5 frames before the transition point and 5 frames after the transition point (Other effects to ease the transition can be used such as a dissolve for varying lengths); and

d) The video transition between the end of the final sub clip and the master clip is also smoothed by a transition effect such as the white flash described above.

The final result is a polished 15 second video featuring visually interesting visual effects based on professional art direction standards, fast moving clip density, and exceptional communication efficiency—all with just three steps by the user (choosing sub clips, recording master clip, choosing music), done in one or two minutes, with no professional editing background skills needed. In this example, the video is automatically uploaded to the user's social networking web site account.

C) Product Sales Video

User is selling a toy car on an auction site such as eBay and films three clips of the toy, including a clip of the toy in the user's hands, and a clip of the toy moving quickly along the floor. The video clips were filmed with the video camera embedded within the invention. Then, with no manual video editing background and just a minute or two, user is able to transform his raw video clips with the invention into a compelling, compact, mini-sales video about his product, using the following steps.
i) STEP 1: in response to a query from device 100, the user indicates that the video to be made is a sales video. Alternatively, device 100 may be preconfigured for the purpose of creating sales videos and distributed to individuals for that purpose. Device 100 determines from a pre-stored look-up table that a sales video uses two master clips. Or, the query from device 100 asks the user how many master clips he wishes to use in the video presentation that is about to be made; and the user indicates that two master clips are desired.
ii) STEP 2: that the user uses the graphic interface of device 100 to select his favorite clips that he previously filmed of the toy. The clips can be of any length, for example, from 1 minute long each to 3 minutes long. The user selects the two example clips above as sub-clips.
iii) STEP 3: device 100 directs the user to create two new video master clips, with the first master clip designated as an opening statement that relates to the content of the first sub-clip chosen by the user, and the second master clip stating content that relates to the second sub-clip selected by the user. Thus, in the first master clip, the user introduces himself and his product, saying “Hi my name is Matt, and today I'm going to be showing you my toy car for sale.” In the second clip, the user films a clip of himself saying “The toy car I have is really one of the best built, fastest moving toy cars available today. If you buy it now you won't be disappointed.” The invention designates the first clip as master clip A and the second clip as a master clip B.
iv) STEP 4: device 100 directs the user to select a music soundtrack.
After the three steps are complete, the invention performs the following transformations:
i) Automatic trims of sub clips. The invention trims down the length of the sub clips automatically. Again, the invention's automatic edit algorithm uses the length of the master clips to determine the automatic trimming of the sub clips; but the rule is different from that used with a single master clip. Generally, introductory statements are divided in half, where the first 50% introduce the presenter and the second 50% introduce the subject. Therefore, in this example, the first sub-clip video will be inserted into the master clip A audio at the 50% point of the length of the master clip A. Additionally, illustrative statements typically benefit from seeing the presenter to put the clip in context, and viewing the subject of the video in more detail during the central portion of the clip. In this example, the video from the second sub-clip will be inserted into the master clip B beginning at the 30% point of the length of master clip B, and the insertion will end 5 seconds prior to the ending of master clip B. Thus, the trimming algorithm can be stated as follows. The length of the two master clips combined will be the length of the final automatically edited video. Taking the combined master clip length and subtracting a buffer time determines the total length available for the sub clips. In this example, the first sub clip (the car in user's hand) will be trimmed to 50% of the length of master clip A, and the second sub clip (car moving fast) will be trimmed to 70% of the length of master clip B minus a 5 second buffer. Thus, if master clip A is 10 seconds, then the first sub clip will be trimmed to 5 seconds, and if master clip B is 20 seconds, then the second sub clip will be trimmed to 9 seconds. Again, the 55% point in the length of each sub clip is set by the invention as the trim middle point (or trimming center). The trim middle point could be a range, but in most cases the trim middle point will be near the middle of the sub clip because statistically when all users create video clips the best material is most often located towards the center point of the clip.
ii) Automatic replacement of master clip video portions with sub-clips. Next, device 100 takes the automatically trimmed sub-clips and inserts them into the video portion of their corresponding master clips leaving a portion of the master video intact. Thus, the invention automatically inserts the video portions of the automatically trimmed sub-clips so that the final video transformed by the invention is sequenced as follows:

a) the first 5 seconds of the video feature the master clip A video and audio (“Hi my name is Matt and” with the user's face showing on camera), then,

b) the next 5 seconds of the final video show the video of the automatically trimmed first sub-clip, at 5 seconds in its automatically trimmed length, with the audio of the master clip playing at the same time (“today’ I'm going to be showing you my toy car for sale” is the audio playing while the first sub-clip—the footage of the car in the user's hands, is displayed visually), then

c) the next 6 seconds of the final video feature the master clip B video and audio (“The toy car I have is really one of” with the user's face showing on camera), then

d) the next 9 seconds of the final video show the video of the automatically trimmed second sub-clip, at 9 seconds in its automatically trimmed length, with the audio of the master clip playing at the same time (“the best built, fastest moving toy cars available today. If you buy” is the audio playing while the second sub-clip—the footage of the car moving fast along the floor, is displayed visually), then

e) the final 5 seconds of the final video show the final 5 seconds of the master clip B video and audio (“it now you won't be disappointed” with the user's face showing on camera). Therefore, instead of sequencing the clips in their original length (30 second combined master clips plus the original sub clip lengths of 1-3 minutes each), the total final automatically edited video is only 30 seconds long, a significant efficiency increase.

iii) automatic additional of visual effects and music. The music track sub-clip chosen by the user is added to the combined master clip soundtrack at a lower volume. In this example, automatically taking 15-45 db off of the volume of the music track will typically be sufficient to hear the music track but not cover up the audio of the master clip. In addition, the following visual effects are automatically added to programmatically enhance the visual interest of the final video transformed by the invention:

a) The beginning of the video is enhanced with a fade up from black;

b) The end of the video is enhanced with a fade down to black;

c) The video transition between the master clip video and the first sub-clip video inserted is smoothed by a transition such as a white flash, in which the video brightness is increased by 20% for 5 frames before the transition point and 5 frames after the transition point (Other effects to ease the transition can be used such as a dissolve for varying lengths); and

d) The video transition between the end of the final sub-clip and the master clip is also smoothed by a transition effect such as the white flash described above.

The final result is a polished 30 second video presentation featuring visually interesting visual effects based on professional art direction standards, fast moving clip density, and exceptional communication efficiency—all with just four steps by the user (selecting the number of master clips, choosing sub-clips, recording master clips, choosing music), done in one or two minutes, with no professional editing background skills needed. In this example, the video is automatically uploaded to a video sharing website so the video can be displayed in the user's auction listing.

Numerous variations may be made in the practice of the invention. Computing device 100 is only illustrative of computing systems and user interfaces that may be used in the practice of the invention. Variations may be practiced in the steps described in FIG. 2; and in some embodiments, some of these steps need not be used at all. For example, some embodiments of the invention, may allow no choice in the number of master clips that are used in forming the finished video presentation and therefore may not provide for a selection of such number by the user. Others may not provide for selection of a music soundtrack for use in the finished video presentation.

What is claimed is:

1. A computing device comprising:
a display;
one or more processors;
memory;
a camera; and
computer software stored in the memory and executable by the one or more processors, said software comprising instructions for:
receiving from a user a selection of video clips;
trimming the length of the selected video clips; and
assembling the video clips into a finished video presentation.

2. The computing device of claim 1 wherein the video clips are stored in the memory of the computing device.

3. The computing device of claim 1 wherein the steps of trimming the length of the selected video clips and assembling the video clips are performed without user intervention.

4. The computing device of claim 1 wherein the instructions for trimming the length of the video clips include instructions for:
locating a trimming center in each video clip; and
locating a trimming start point and a trimming end point relative to the trimming center in each video clip.

5. The computing device of claim 4 wherein the trimming center of each video clip is located at X percent of the temporal duration of the video clip where X is between 40 and 70 percent of the temporal duration of the video clip.

6. The computing device of claim 5 wherein X is the same for each of the video clips.

7. The computing device of claim 5 wherein X is selected as a function of the length of the clip.

8. The computing device of claim 5 wherein the value of X depends on the type of video presentation.

9. The computing device of claim 1 further comprising instructions for:
receiving an audio selection from the user; and
inserting the selected audio into the finished video presentation.

10. The computing device of claim 1, wherein the software further comprises instructions for:
receiving from the user a master video clip; and
replacing portions of the master video clip with the trimmed video clips to form the finished video presentation.

11. The computing device of claim 10 further comprising the step of directing the user to make the master video clip.

12. The computing device of claim 10 wherein the software further comprises instructions to automatically insert visual effects into the final video presentation based on the beginning and end of the master video clip and transitions between the master video clip and the trimmed video clips that are inserted into the master video clip.

13. The computing device of claim 1 wherein at least one video clip is created by animating one or more still images.

14. The computing device of claim 1, wherein the computing and/or camera device is located in the user's proximity, or wherein the user utilizes an Internet connected computer to operate the computing device via an Internet connection, or wherein the user utilizes an Internet connected computer and camera to operate the computing device via an Internet connection.

15. A method of making a video presentation comprising:
receiving at a computer selection information for a plurality of video clips stored in the computer;
recording at the computer a master clip relating to the selected video clips; and
automatically replacing video portions of the master clip with video portions of the selected video clips to form the video presentation.

16. The method of claim 15 further comprising the step of directing the user to record the master clip.

17. The method of claim 15 further comprising the step of automatically applying visual effects to the video presentation.

18. The method of claim 15 further comprising the step of automatically trimming the temporal duration of the selected video clips.

19. The method of claim 18 wherein the method of automatically trimming comprises:
locating a trimming center in each video clip; and
locating a trimming start point and a trimming end point relative to the trimming center in each video clip.

20. The method of claim 19 wherein the trimming center of each video clip is located at X percent of the temporal duration of the video clip where X is between 40 and 70 percent of the temporal duration of the video clip.

21. The method of claim 20 wherein X is the same for each of the video clips.

22. The method of claim 20 wherein X is selected as a function of the length of the clip.

23. The method of claim 20 wherein the value of X depends on the type of video presentation.

24. The method of claim 15 further comprising the step of automatically adding an audio soundtrack at a reduced volume to the finished video presentation.

25. The method of claim 15 further comprising the step of transferring the video presentation to a database server for network based delivery.

26. A method of preparing a finished video presentation comprising:
receiving at a computer a selection of video clips stored in the computer;
trimming with the computer the length of the selected video clips: and
assembling the trimmed video clips in the computer into the finished video presentation.

27. The method of claim 26 further comprising the step of receiving at the computer a master video relating to the selected video clips and the step of assembling the trimmed video clips comprises replacing portions of the master video with the trimmed video clips.

28. The method of claim 27 further comprising the step of directing the user to make a master video.

29. The method of claim 26 wherein the step of trimming the length of the selected video clips comprises:
locating a trimming center in each video clip; and
locating a trimming start point and a trimming end point relative to the trimming center in each video clip.

30. The method of claim 26 further comprising the step of transferring the resultant video to a database server for network based delivery.

31. The method of claim 26 further comprising the step of automatically enhancing the video with additional audio and/or visual effects.
